(19) United States
(12) Patent Application Publication
(10) Pub. No.: US 2019/0126345 A1
(43) Pub. Date: May 2, 2019

(54) DIRECTIONAL SOLIDIFICATION APPARATUS AND RELATED METHODS

(71) Applicant: United Technologies Corporation, Farmington, CT (US)

(72) Inventor: Mario P. Bochiechio, Vernon, CT (US)

(21) Appl. No.: 16/224,646

(22) Filed: Dec. 18, 2018

Related U.S. Application Data
(62) Division of application No. 15/109,060, filed on Jun. 29, 2016.
(60) Provisional application No. 61/921,574, filed on Dec. 30, 2013.

(51) Int. Cl. B22D 27/04; F01D 5/12; F01D 5/28; B22D 27/00; F01D 5/14; B22D 18/04; B22D 27/15

(52) U.S. Cl. CPC B22D 27/045; F01D 5/12; F01D 5/286; B22D 27/003; F01D 5/14; B22D 27/006; F05D 2300/10; B22D 18/04; B22D 27/15; F05D 2300/605; F05D 2300/606; F05D 2300/607; F01D 5/28

(57) ABSTRACT

A directional solidification apparatus includes a mold heating chamber, a solidification chamber, and a gas source. The solidification chamber is adjacent the mold heating chamber for solidifying molten metal formed from an air melt allow system as a cast body as the metal is withdrawn from the mold heating chamber. The gas sources is in fluid communication with the mold heating chamber for providing a pressurized atmosphere for directionally solidifying metal as cast body having single crystal or multi-crystal columnar micro structure.

### CROSS-REFERENCE TO RELATED APPLICATIONS

This is a divisional of U.S. application Ser. No. 15/109,060 filed Jun. 29, 2016, which is a national stage of PCT application PCT/US2014/068772 filed Dec. 5, 2014, which claims priority to U.S. provisional application 61/921,574 filed Dec. 30, 2013, the disclosure of which is incorporated herein by reference in its entirety.

### BACKGROUND

The present disclosure relates to apparatus and methods for casting, and more particularly to apparatus and methods for directionally solidifying cast bodies.

Gas turbine engines include components that can be subject to extreme temperature and stress during engine operation. Such components, like blades, vanes, and blade outer air seals, are typically constructed from nickel-based superalloy castings because the high number of slip planes present in the face-centered cubic microstructures of such materials is well suited to extreme temperature and high stress applications. Examples of castings formed from nickel-based alloys and superalloys are described in U.S. Pat. No. 3,260,505 to Ver Synder and U.S. Pat. No. 3,494,709 to Piearcy, the contents of which are incorporated herein by reference in their entirety.

Nickel-based alloy and superalloy castings, i.e. vacuum melt alloy systems, are generally formed by directionally solidifying molten metal in dual chamber vacuum induction furnaces. Such furnaces typically include an upper mold heating chamber for receiving molten metal in a mold and a lower cooling chamber is adapted for maintaining a steep thermal gradient within the mold as the mold is withdrawn from the upper chamber into the lower chamber. Solidification generally occurs under vacuum, thereby developing a nickel-based alloy or superalloy casting with single crystal or multi-crystal columnar microstructure. Examples of induction furnaces suitable for vacuum melt alloy systems include those described in U.S. Pat. No. 3,763,926 to Tschinkel, and U.S. Pat. No. 4,108,236 to Salkeld, the contents of which are herein incorporated by reference.

Such conventional apparatus and methods have generally been considered satisfactory for their intended purpose. However, there is a need in the art for induction furnaces and casting methods suitable for casting single crystal or multi-crystal columnar castings formed from air melt alloy systems, such as carbon steel or low-alloy steels for example. The present disclosure provides a solution for this need.

### SUMMARY OF THE INVENTION

A directional solidification apparatus includes a mold heating chamber, a solidification chamber, and a gas source. The solidification chamber is adjacent the mold heating chamber for directionally solidifying a cast body as the body is withdrawn from the mold heating chamber. The gas source is in fluid communication with the mold heating chamber for providing a pressurized atmosphere to the molten metal during solidification for solidifying the cast body as a single crystal or multi-crystal columnar cast body.

In certain embodiments, the mold is configured for directionally solidifying a charge of molten metal formed from an air melt alloy system such as carbon steel, low alloy steel, or non-nickel based alloy under an inert or oxidizing environment. A valve, such as a gate valve, can be operatively associated with apparatus for selectively placing the interior of the apparatus in fluid communication with the gas source. A cooling module can provide cooling to the valve.

In accordance with certain embodiments, the gas source can be an oxidizing gas source or an inert gas source, such as argon, nitrogen, or mixtures thereof. A heating element can be arranged within an interior portion of the mold heating chamber. A baffle can separate the mold heating chamber from the solidification chamber for limiting radiant heating of the solidification chamber. The baffle can be constructed from an oxide-based ceramic material or a material suitable for use in a high-temperature environment with an oxidizing or inert atmosphere, such as alumina, partially stabilized zirconia, alumina-silicate, or cordierite for example.

It is contemplated that the apparatus include a gas impingement module in fluid communication with the solidification chamber for removing heat from the directionally solidified cast body using air. A water ring can be disposed within the solidification chamber for removing heat from the cast body using a liquid cooling medium. The interior of the apparatus can be a hyperbaric controlled environment for reducing volatile migration from the metal as it solidifies into a cast body. The interior of the apparatus can provide a controlled, low vacuum environment for directionally solidifying the cast body with single crystal or multi-crystal columnar microstructure.

A method of casting air melt alloy systems includes introducing molten metal formed from an air melt alloy system into a mold heating chamber under a controlled atmosphere, withdrawing the molten metal from the mold heating chamber and into a solidification chamber adjacent the mold heating chamber under the controlled atmosphere, and removing heat from the molten metal, thereby forming a directionally solidified cast body formed from a single crystal or a multi-crystal columnar microstructure within the controlled atmosphere.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a cross-sectional side view of a casting apparatus constructed in accordance with the present disclosure, showing an apparatus interior for solidifying molten metal within an inert atmosphere;

FIG. 2 is a cross-sectional side view of a second embodiment of a casting apparatus constructed in accordance with the present disclosure, showing an apparatus interior for solidifying molten metal within an oxidizing atmosphere;

FIG. 3 is a cross-sectional side view of a third embodiment of a casting apparatus constructed in accordance with the present disclosure, showing an apparatus for solidifying molten metal within an inert or oxidizing atmosphere using a liquid metal bath;

FIGS. 4A, 4B, 4C and 4D are cross-sectional views of a directionally solidified cast body in accordance with the present disclosure after etching with a first reagent, showing body microstructure; and

FIGS. 5A, 5B, 5B, and 5D are cross-sectional views of the directionally solidified cast body after etching with a second reagent, showing body microstructure; and

FIG. 6 is a method of directionally solidifying molten metal comprised of an air melt alloy system as a cast body having single crystal or multi-crystal columnar microstructure.

### DETAILED DESCRIPTION OF THE PREFERRED EMBODIMENTS

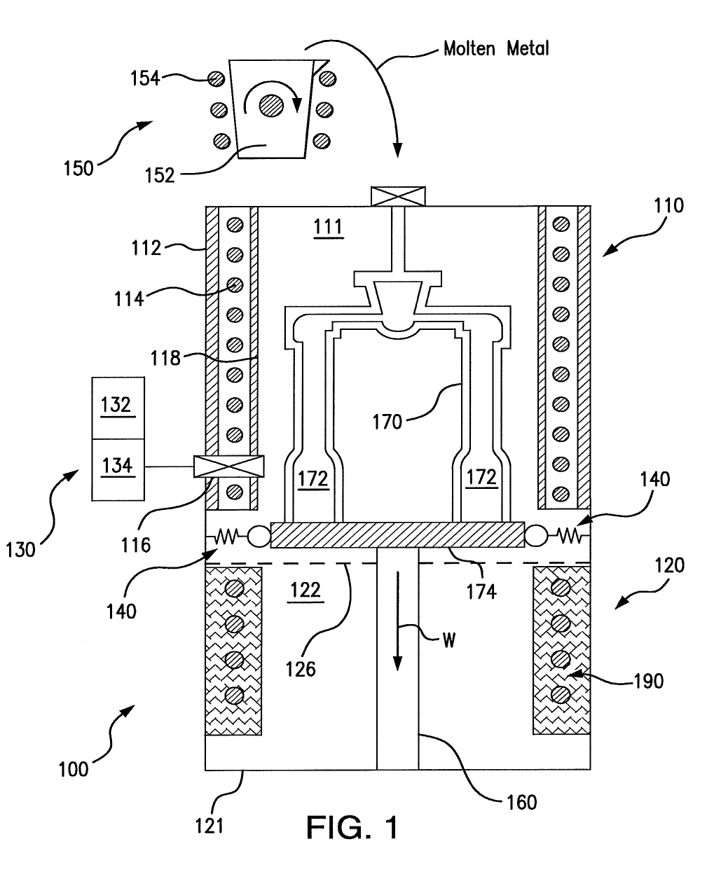

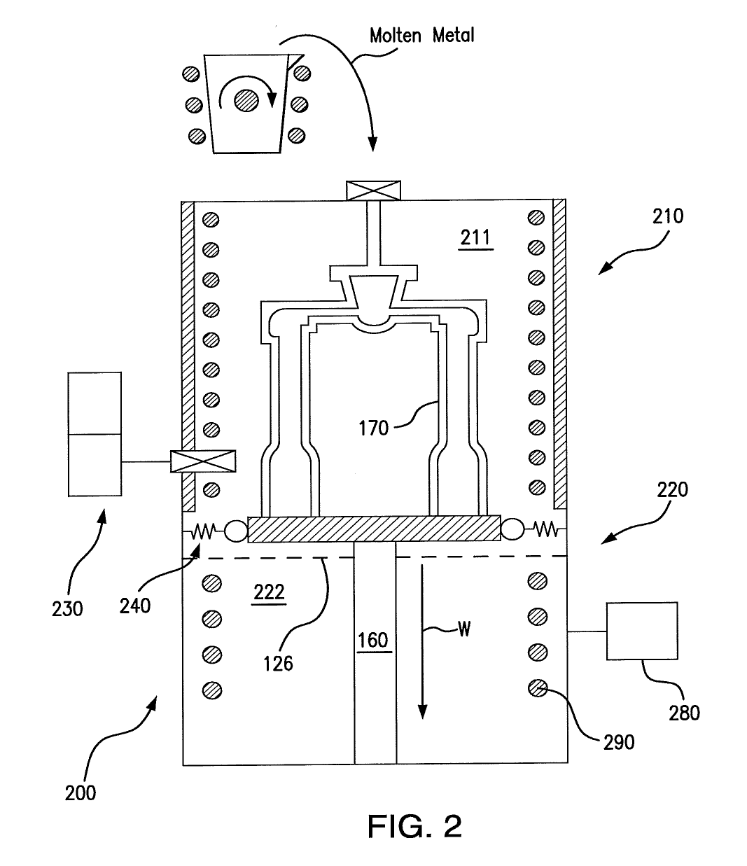

Reference will now be made to the drawings wherein like reference numerals identify similar structural features or aspects of the subject disclosure. For purposes of explanation and illustration, and not limitation, a partial view of an exemplary embodiment of a casting apparatus in accordance with the disclosure is shown in FIG. 1 and is designated generally by reference character 100. Other embodiments of the casting apparatus in accordance with the present disclosure, or aspects thereof, are provided in FIGS. 2-6, as will be described. The systems and methods described herein can be used for directionally solidifying molten metal comprising air melt alloy systems as castings having single crystal or multi-crystal columnar microstructure.

With reference to FIG. 1, a casting apparatus 100 is shown. Casting apparatus 100 includes a mold heating chamber 110, a solidification chamber 120, a gas source 130, and a baffle 140. Casting apparatus 100 is operatively associated with a melt box 150 and a withdrawal mechanism 160. Casting apparatus 100 includes a mold 170 movably disposed within its interior for receiving a charge of molten metal. It is contemplated that the molten metal comprises an air melt alloy system, such as carbon steel, low alloy steel or copper-nickel alloy for example.

Mold heating chamber 110 is arranged above and adjacent to solidification chamber 120. Baffle 140 separates mold heating chamber 110 from solidification chamber 120 and has an aperture configured to conform to a portion of mold 170 disposed within the aperture. Melt box 150 is operatively associated with mold heating chamber 110 and is configured for transferring molten metal into mold 170 when mold 170 is positioned in an upper portion of mold heating chamber 110. Withdrawal mechanism 160 is operatively associated with mold heating chamber 110 and solidification chamber 120 and configured for transferring mold 170 from mold heating chamber 110 into solidification chamber 120 along withdrawal axis W.

Mold heating chamber 110 has an interior 111 configured for being pneumatically isolated from the atmosphere external to apparatus 100. Mold heating chamber 110 includes an insulating body 112, heating elements 114 such as induction coils or resistive heating elements, a valve 116, and a susceptor 118. Heating elements 114 are disposed within mold heating chamber 110 between insulating body 112 and susceptor 118 and are in thermal communication with susceptor 118. Susceptor 118 is a graphite body configured for uniformly distributing heat generated by heating elements 114 within interior 111 of mold heating chamber 110. Insulating body 112 also has an aperture disposed in its upper portion configured for receiving molten metal from melt box 150 and selectively separating interior 111 of mold heating chamber 110 from the atmosphere external to apparatus 100. Baffle 140 bounds mold heating chamber 110 on its lower portion and separates interior 111 from solidification chamber 120, thereby reducing radiant heating of solidification chamber 120 by elements within mold heating chamber 110.

Solidification chamber 120 includes a housing 121 defining an interior 122 and an isolation valve 126. Interior 122 is configured to receive mold 170 as mold 170 advances along withdrawal axis W. Interior 122 is bounded on its upper end by baffle 140 and by housing 121 about its periphery. Housing 121 optionally includes a water cooled chill ling 190. Water cooling ling 190 can be in fluid communication with a supply of liquid coolant, e.g., water, and in thermal communication with interior 122. Isolation valve 126 is configured to separation mold heating chamber 110 from solidification chamber 126 once mold 170 has been withdrawn below isolation valve 126. This allows for removing mold 170 without exposure of the interior of mold heating chamber 110 to the atmosphere external to apparatus 100.

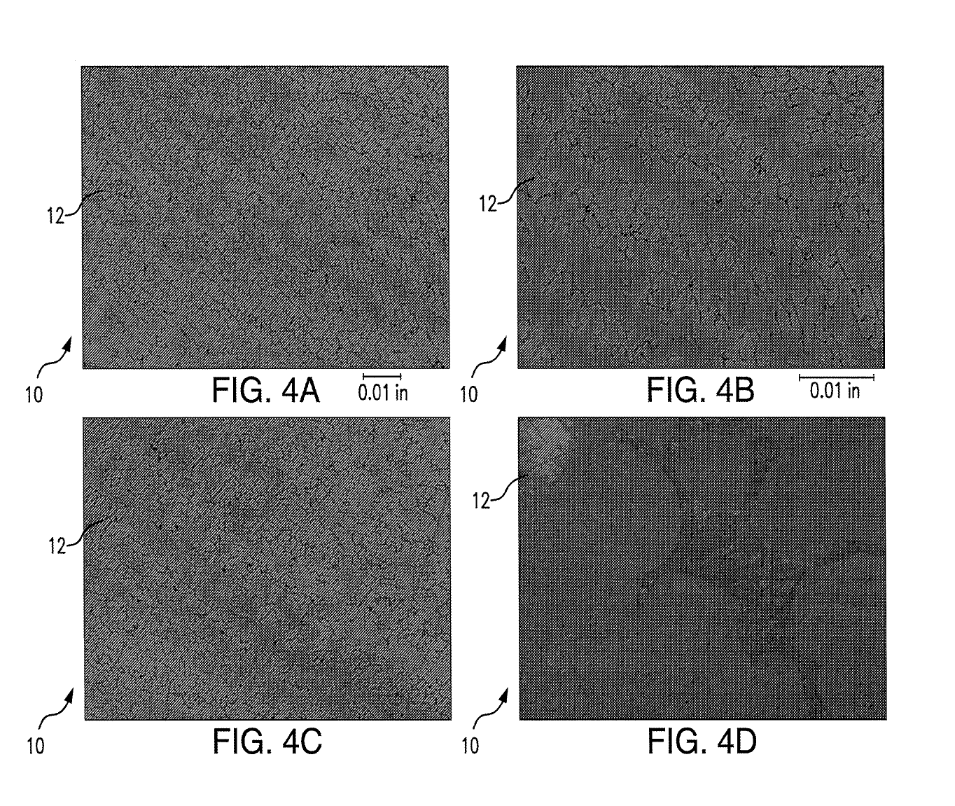

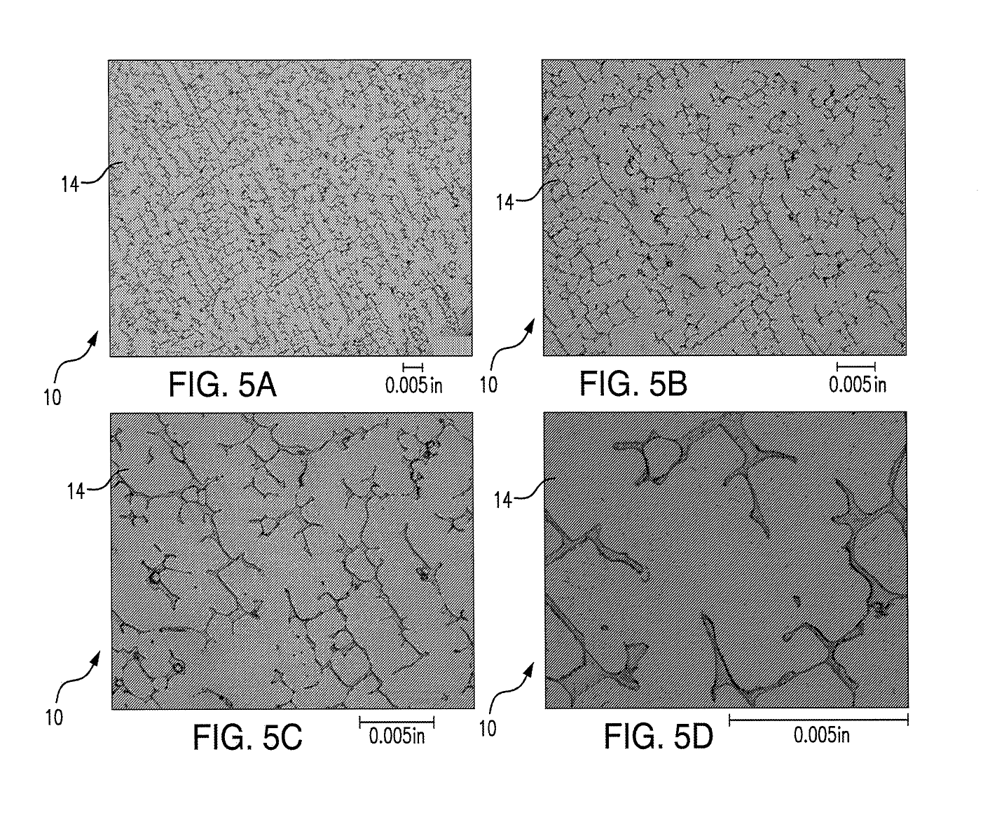

Gas source 130 includes a gas source 132, a vacuum source 134, and valve 116. Gas source 132 is in selective fluid communication with interior 111 through valve 116. Vacuum source 134 is also in selective fluid communication with interior 111 through valve 116. Valve 116 is configured for selectively placing gas source 130 and vacuum source 134 in selective fluid communication through valve 116 with interior 111, thereby controlling the internal atmosphere of apparatus 100 during solidification of molten metal disposed within mold 170. This allows for evacuating interior 111 of air and charging interior 111 with an inert atmosphere. Charging interior 111 with an inert atmosphere in turn prevents evaporation of air melt alloy constituents with relatively low vapor pressures, such as chromium or aluminum, potentially changing the constitution of the alloy forming cast body 10 (shown in FIG. 4 and FIG. 5) from that of the molten metal delivered to mold 170. This can also reduce or prevent defects from forming in the body during solidification that could otherwise develop due to the relatively low vapor pressure of constituents of the molten metal were the body solidified under vacuum.

It is contemplated that the gas source can be an inert gas source. The gas source can be a nitrogen supply or an argon supply for directionally solidifying cast body 10 (shown in FIG. 4 and FIG. 5) in a nitrogen atmosphere or an argon atmosphere. It is also contemplated that vacuum source 134 can be configured to evacuate interiors 111 and/or 122 and backfill interiors 111 and 122 with an inert gas at a controlled pressure. The controlled pressure can be hyperbaric, e.g. above 1 atmosphere. Alternatively, the controlled pressure can be hypobaric, e.g. between about 0.5 atmosphere to about 1 atmosphere (0.506 bar to about 1.013 bar).

Valve 116 can be a gate valve. Valve 116 can optionally be provisioned with cooling such that heat conducted to valve 116 by the atmosphere within apparatus 100 does not adversely impact the reliability of valve 116.

Melt box 150 includes a vessel 152 and heater elements 154 operatively associated with vessel 152. Heater elements 154 are configured for heating vessel 152 and contents thereof. This enables delivering a charge of molten metal comprising an air melt alloy system to mold 170. Heater elements 154 can be induction coils or resistive heating elements, for example.

Withdrawal mechanism 160 is operatively associated with mold 170 and includes a chill plate 174. Withdrawal mechanism 160 connects to a lower portion of mold 170 and is configured for displacing mold 170 between interior 111 of mold heating chamber 110 and interior 122 of solidification chamber 120 along withdrawal axis W. Withdrawal mechanism 160 is also configured for positioning mold 170 in an upper portion of interior 111 to receive molten alloy from melt box 150. Withdrawal mechanism 160 thereafter progressively withdraws mold 170 through interior 111 and into interior 122, maintaining a consistent thermal gradient within mold 170 for directionally solidifying molten metal disposed within mold 170 as a cast body 10 (shown in FIG. 4 and FIG. 5) with single crystal or multi-crystal columnar microstructure developed under an inert atmosphere.

Mold 170 can be a ceramic shell mold with cavities 172 for forming cast bodies 10 (shown in FIG. 4 and FIG. 5). Cavities 172 have axially extending shape with a lower portion configured for transferring heat from the lower portions of cavities 172. It is contemplated that cavities 172 can have the inverse shape needed for forming a component that can exploit the advantages of a single crystal structure, e.g. creep resistance, such as turbine blades for example. Cavities 172 are configured for receiving molten metal and transferring heat from the molten metal through a chill plate coupled to a lower portion of mold 170.

With reference to FIG. 2, a casting apparatus 200 is shown. Casting apparatus 200 is similar to casting apparatus 100 and is additionally configured for directionally solidifying cast bodies 10 (shown in FIG. 4 and FIG. 5) in an oxidizing environment. Casting apparatus 200 includes a mold heating chamber 210, a solidification chamber 220, a gas source 230, and a baffle 240. Casting apparatus 200 also includes an air impingement module 280 and a water cooling ring 290.

Gas source 230 is configured for providing and sustaining an oxidizing atmosphere within either or both of an interior 211 of mold heating chamber 210 and an interior 222 of solidification chamber 220 for solidifying molten metal introduced into mold 170. Mold heating chamber 210 and baffle 240 are constructed on an inflammable material for withstanding the high temperature oxidizing environment maintained within interior 211 while directionally solidifying molten metal within mold 170.

Gas impingement module 280 is in fluid communication with interior 222 of solidification chamber 220, and provides a flow of compressed air, nitrogen, helium, argon, or other suitable compressed medium to mold 170 for cooling molten metal disposed therein. Water cooling ring 290 is in fluid communication with a supply of liquid coolant, e.g., water, and is in thermal communication with interior 222. Each gas impingement module 280 and water cooling ring 290 are configured for removing heat from the molten alloy within mold 170 as it advances along withdrawal axis W, thereby maintaining a suitable thermal gradient within mold 170 for developing cast bodies 10 (shown in FIG. 4 and FIG. 5) having single crystal or multi-crystal columnar microstructure.

Conventional susceptor and baffle assemblies used for vacuum melt alloy systems are generally constructed from materials unsuitable for oxidizing environments, such as graphite. Because apparatus 200 directionally solidifies molten metal within an oxidizing atmosphere, apparatus 200 includes baffle 240 constructed from material suitable for use in a high-temperature environment with an oxidizing atmosphere. Examples of such materials include oxide-based ceramic materials, alumina, partially stabilized zirconia, alumina-silicate, or cordierite. Baffle 240 can also be constructed from compressed fibers, such as aluminosilicate-based fiber board for example. This potentially provides a casting environment suitable for developing cast bodies 10 (shown in FIG. 4 and FIG. 5) formed from air melt alloy system with single crystal or multi-crystal columnar microstructure. It is also contemplated that baffle 240 can be constructed from individual leaves configured for moving as the mold advances into the solidification chamber, thereby conforming to variation in the cross-sectional shape of mold 170. Baffle 240 can also be a static structure configured to remain fixed as the mold advances into the solidification chamber.

Notably, casting apparatus 200 does not include a susceptor constructed from graphite. Instead, casting apparatus 200 includes heating elements 214 distributed within interior 211 to achieve similar heating effect as that achieved using a susceptor. This allows for directionally solidifying air melt allow systems as cast bodies with single crystal or multi-crystal columnar microstructure and preventing evaporation of alloy constituents with low vapor pressure into the chamber atmosphere, such as chromium or aluminum, potentially changing the constitution of the alloy forming cast body 10 (shown in FIG. 4 and FIG. 5) from that of the molten alloy delivered to mold 170. Moreover, it also allows for directionally solidifying cast bodies within apparatus 200 within an oxidizing atmosphere such as air that is readily available and relatively inexpensive.

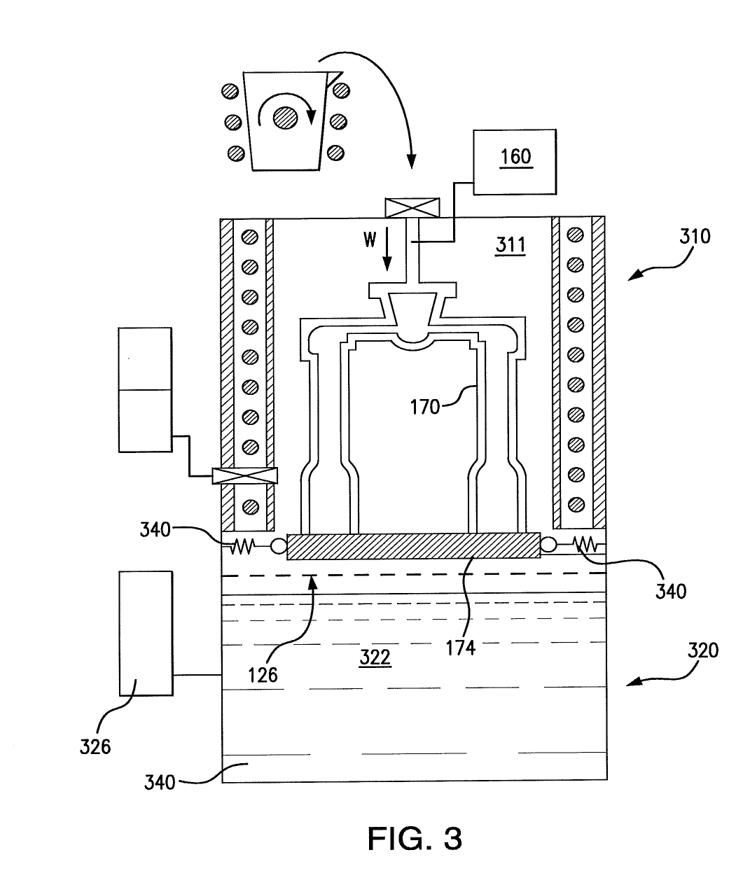

With reference to FIG. 3, a casting apparatus 300 is shown. Casting apparatus 300 is similar to casting apparatus 100 and additionally includes a liquid metal bath 322, skimming mechanism 326, and baffle 340. Withdrawal mechanism 160 is operatively associated with mold 170 for driving mold 170 into liquid metal bath 322. Liquid metal bath 322 is adapted for receiving mold 170 as it advances along withdrawal axis W and transferring heat therefrom, thereby assisting water-cooled chill plate 174 in maintaining a thermal gradient within mold 170. Liquid metal bath 324 can include tin, indium, copper, copper-indium, copper-antimony, aluminum, or aluminum-copper by way of non-limiting example.

Baffle 340 is configured for maintaining heat within liquid metal bath 324 and is optional in embodiments of casting apparatus 300 configured for certain liquid metal cooling processes. In embodiments including baffle 340, baffle 340 prevents liquid metal from evaporating from liquid metal bath 324 into the atmosphere of interior 311 of mold heating chamber 310. This allows for maintaining relatively low vapor pressures within mold heating chamber interior 311 of mold heating chamber 310, e.g. less than 1 atmosphere (about 101 kilopascals).

With reference to FIGS. 4A-4D, views of a first transverse section 12 of an example cast body 10 is shown. Example cast body 10 is a single crystal cast steel body formed from carbon steel alloy conforming to current AMS5362 specifications, e.g. AMS5362 rev 9, formed using casting apparatus 100. First transverse section 12 is a cross-section taken in an x-y plane orthogonal with respect solidification axis z (corresponding to withdrawal axis W discussed above). Prior to acquiring the images presented in FIG. 4, transverse section 12 was etched using Fry's Reagent to expose dendrites 14 and grain boundaries as applicable. This was accomplished by immersing a transverse section of example cast body 10 taken orthogonally with respect to the crystal growth axis and swabbing the section surface with a mixture of about 5 grams of copper chloride per 40 milliliters of hydrochloric acid, 25 milliliters of ethanol, and 30 milliliters of water.

FIG. 4A and FIG. 4C show microstructure of first transverse section 12 magnified 50 times. FIG. 4B shows microstructure of first transverse section 12 magnified 75 times. FIG. 4D shows microstructure of first transverse section 12 magnified 400 times.

Notably, no grain boundaries are visible in the transverse sectional images shown in FIGS. 4A-4D. This indicates that the AMS5362 material forming example cast body 10 has a single crystal microstructure. Also notable in FIGS. 4A-4D are that the dendrites formed within the microstructure have primary and secondary orientations that are substantially orthogonal with respect to one another. This indicates that cast bodies formed from air melt alloy systems such as AMS5362 (shown) are amenable to seeding for controlling both the primary and secondary solidification orientations of the material.

With reference to FIGS. 5A-5D, a second transverse section 14 of example cast body 10 is shown. Second transverse section 14 is similar to transverse section 12 with the difference that the section was etched using Kialing's Reagent. Kialing's reagent is a mixture of about containing 5 grams of copper chloride per 100 milliliters of hydrochloric acid and 100 milliliters of ethanol. The reagent was applied to second transverse section 14 for purposes of making the microstructure of example cast body 10 readily visible for optical inspection.

FIG. 5A shows microstructure of second transverse section 14 magnified 38 times. FIG. 5B shows microstructure of second transverse section 14 magnified 74 times. FIG. 5C shows microstructure of second transverse section 14 magnified 150 times. FIG. 5D shows microstructure of second transverse section 14 magnified 350 times.

Notably, no grain boundaries are visible in FIGS. 5A-5D. The lack of grain boundaries indicates that directionally solidified example cast body 10 has single crystal microstructure. Dendrites visible in FIGS. 5A-5D show primary and secondary orientations orthogonal with respect to one another, indicating once again that the cast carbon and low alloy steels such as AMSS362 are amenable to seeding processes used for nickel-based superalloys for controlling crystal growth.

While a single example material is illustrated in the accompanying figures, it will be appreciated that the apparatus and methods described herein are suitable for other air melt alloy systems such as stainless steels, monel (i.e. copper-nickel alloy systems), brass, copper-chromium, or high-alloy coppers such as GRCop 84 conforming with NASA/TM-2005-213566 specifications. While single crystal microstructure is illustrated in the accompanying figures, it will also be appreciated that cast bodies formed using directional solidification such as through directionally solidified columnar casting can also be formed using the apparatus and methods described herein.

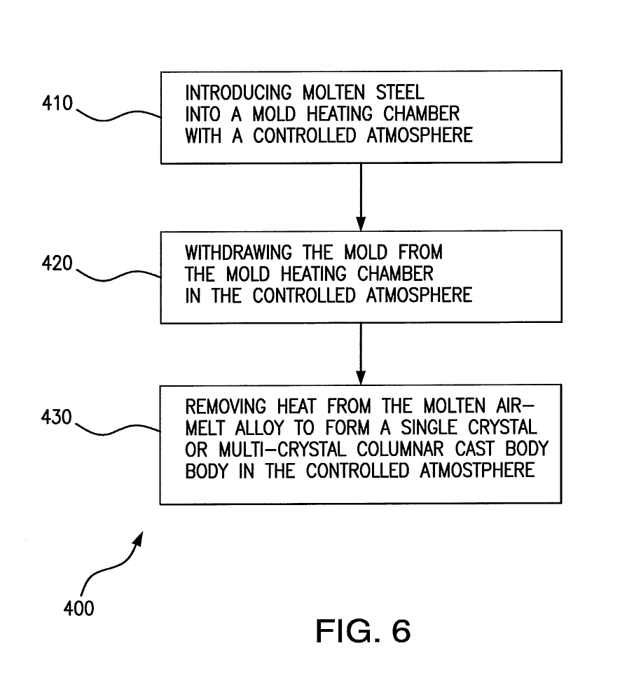

With reference to FIG. 6, a method 400 of forming a cast body is shown. Method 400 includes the steps of (a) introducing 410 molten metal comprised of an air melt alloy into a mold heating chamber in a controlled atmosphere, (b) withdrawing 420 the molten metal into a solidification chamber in the controlled atmosphere, and (c) removing 430 heat from the molten metal under positive pressure to form a single crystal or multi-crystal columnar cast body formed from the air melt alloy system in the controlled atmosphere. The controlled atmosphere can be a positive pressure atmosphere, such as an inert atmosphere or oxidizing atmosphere as described above.

Controlling the atmosphere within which molten air melt alloys such as carbon steel or low alloy steel is solidified can reduce splitting and/or alloy volatiles from exiting the molten material during solidification. This allows for forming cast bodies formed from air melt alloy systems with single crystal or multi-crystal columnar microstructure without significant alterations of the alloy chemistry that could otherwise develop during solidification of the due to the vapor pressure(s) of some alloying constituents present in the alloy. Such cast bodies in turn can have superior mechanical properties, such as creep resistance, thereby allowing for construction of gas turbine engine components such as turbine blade which are currently limited to nickel-based steels and/or superalloys.

The methods and systems of the present disclosure, as described above and shown in the drawings, provide for casting apparatuses and techniques with superior properties including the ability to directionally solidify castings as a single crystal or columnar castings formed from non-esoteric (or exotic) air melt alloy systems. This can provide materials with anisotropic physical properties suitable for applications presently served by materials with isotropic properties but which could benefit from materials with anisotropic properties by adapting design methodologies known in aerospace but not generally applied in other applications, such as automotive and other industrial applications for example. While the apparatus and methods of the subject disclosure have been shown and described with reference to preferred embodiments, those skilled in the art will readily appreciate that changes and/or modifications may be made thereto without departing from the spirit and scope of the subject disclosure.

What is claimed is:

1. A method of casting a metal, comprising:
introducing molten metal comprising a carbon steel, low alloy steel, or a non-nickel based alloy system into a mold heating chamber in a controlled atmosphere;
withdrawing the molten metal into a solidification chamber in the controlled atmosphere; and
removing heat from the molten metal in a controlled atmosphere and developing a directionally solidified cast body with single crystal or a multi-crystal columnar microstructure.

2. A method as recited in claim 1, wherein the controlled atmosphere is a controlled inert atmosphere.

3. A method as recited in claim 2, wherein the controlled inert atmosphere is an argon atmosphere.

4. A method as recited in claim 2, wherein the controlled inert atmosphere is a positive pressure inert atmosphere.

5. A method as recited in claim 1, wherein the controlled inert atmosphere is a low vacuum inert atmosphere.

6. A method as recited in claim 1, wherein the controlled atmosphere is a controlled oxidizing atmosphere.

7. A method as recited in claim 6, wherein the controlled oxidizing atmosphere is a positive pressure oxidizing atmosphere.

8. A method as recited in claim 6, wherein the controlled oxidizing atmosphere is a low vacuum oxidizing atmosphere.

9. A method as recited in claim 1, further comprising removing heat from the metal to a liquid metal bath.

10. A method as recited in claim 1, further comprising removing heat from the metal with an air impingement module in fluid communication with the solidification chamber.

11. A method as recited in claim 1, further comprising removing heat from the metal to a water ring comprising a liquid coolant disposed within the solidification chamber.

12. A method as recited in claim 1, further comprising evacuating an interior of the apparatus and charging the atmosphere with an inert gas for solidifying the cast body.

13. A method as recited in claim 1, wherein the controlled atmosphere is a hyperbaric controlled environment for reducing migration of volatile alloy constituents from molten metal to the apparatus interior during solidification of the cast body.

14. A method as recited in claim 1, wherein controlled atmosphere is a hypobaric controlled environment for reducing migration of volatile alloy constituents from molten metal to the apparatus interior during solidification of the cast body.

15. A method as recited in claim 1, wherein the molten metal comprises aluminum.

16. A method as recited in claim 1, wherein the molten metal comprises chromium.
